(19) United States
(12) Patent Application Publication
(10) Pub. No.: US 2024/0281455 A1
(43) Pub. Date: Aug. 22, 2024

(54) TUNING-FREE UNSUPERVISED ANOMALY DETECTION BASED ON DISTANCE TO NEAREST NORMAL POINT

(71) Applicant: Oracle International Corporation, Redwood Shores, CA (US)

(72) Inventors: Youssef Mohamed Saied, Zurich (CH); Mohamed Ridha Chahed, Saied (CH); Anatoly Yakovlev, Folsom, CA (US); Sandeep R. Agrawal, Fremont, CA (US); Sanjay Jinturkar, Basking Ridge, NJ (US); Nipun Agarwal, Saratoga, CA (US)

(73) Assignee: Oracle International Corporation, Redwood Shores, CA (US)

(21) Appl. No.: 18/444,454

(22) Filed: Feb. 16, 2024

Related U.S. Application Data
(60) Provisional application No. 63/446,274, filed on Feb. 16, 2023.

(51) Int. Cl. G06F 16/28; G06F 16/22

(52) U.S. Cl. CPC G06F 16/285; G06F 16/2282

(57) ABSTRACT

Disclosed is an improved approach to implement anomaly detection, where an ensemble detection mechanism is provided. An improvement is provided for the KNN algorithm where scaling is applied to permit efficient detection of multiple categories of anomalies. Further extensions are used to optimize local anomaly detection.

### CROSS-REFERENCE TO RELATED APPLICATIONS

The present application claims the benefit of priority to U.S. Provisional Application No. 63/446,274, which is hereby incorporated by reference in its entirety.

### BACKGROUND

Identification of abnormal instances in a dataset is typically referred to as anomaly detection. Anomaly detection is used to identify events, items, or observations which are suspicious because they differ significantly from standard behaviors or patterns. Anomalies in data are also called standard deviations, outliers, noise, novelties, and exceptions.

Anomaly detection may be useful in any number of different contexts. As just one example, anomaly detection may be used to identify suspicious activity at or with regards to a database. This may occur, for instance, with respect to the type, pattern, timing, activities, or source of access that is made to a database to perform a database transaction.

A straight-forward anomaly detection algorithm can be implemented to define a region representing normal behavior, and any observation that is outside that region is considered anomalous. In addition, there are many other algorithms that detect anomalies in a more complex manner. Some examples are nearest neighbor, clustering, and subspace. These algorithms are all different, but what they have in common is that they all, internally, use a decision function that produces scores, called anomaly scores. These anomaly scores are generated by the algorithm per instance (e.g., row in a database table) of the training or test dataset. The higher the anomaly score, the higher the probability that the instance is anomalous. Based on a user provided contamination factor, which is the percentage of anomalies in the dataset, the algorithm can set a threshold, above which the instances are considered anomalous.

Unfortunately, conventional anomaly detection algorithms are often not easily used by lay persons, but instead tend to require the services of a highly skilled and experienced technical specialist in order to operate at an optimum level. For example, certain anomaly detection algorithms require the selection and/or tuning of various parameters for the proper operation of the system to accurately detect anomalies. The problem is that the non-specialist will often not have the proper background or experience to be able to select or tune the required parameters, and the incorrectly selected value may render the detection process to become either unreliable or highly inefficient.

Another issue with conventional anomaly detection algorithms is that they tend to be very specialized to detect only certain types of anomalies, while not being able to reliably detect other types of anomalies. For example, consider anomalies such as the “global”, “clustered”, and “local” type anomalies. The global anomaly pertains to the type anomaly that corresponds to isolated data outliers. The clustered anomaly pertains to a set of data points that may group with each other, but overall still correspond to anomalies when compared to normal data. The local anomaly pertains to isolated data items that may look similar to and has a close distance to good data, but which is actually anomalous data. With known approaches, some algorithms are much better at detecting global anomalies but not very good at detecting other anomalies. Similarly, algorithms exist which are good at detecting clustered anomalies but not so good at detecting the global and local anomalies. Yet further, there are algorithms that are good at detecting local anomalies, but deficient at detecting the other anomaly types.

Therefore, there is a need for an improved approach to implement anomaly detection which addressed the problems identified above.

### SUMMARY

Some embodiments of the present invention provide an improved approach to implement anomaly detection, where an ensemble detection mechanism is provided. An embodiment is directed to an improvement to the KNN algorithm where scaling is applied to permit efficient detection of multiple categories of anomalies.

Further details of aspects, objects, and advantages of the invention are described below in the detailed description, drawings, and claims. Both the foregoing general description and the following detailed description are exemplary and explanatory, and are not intended to be limiting as to the scope of the invention.

### BRIEF DESCRIPTION OF THE FIGURES

The drawings illustrate the design and utility of some embodiments of the present invention. It should be noted that the figures are not drawn to scale and that elements of similar structures or functions are represented by like reference numerals throughout the figures. In order to better appreciate how to obtain the above-recited and other advantages and objects of various embodiments of the invention, a more detailed description of the present inventions briefly described above will be rendered by reference to specific embodiments thereof, which are illustrated in the accompanying drawings. Understanding that these drawings depict only typical embodiments of the invention and are not therefore to be considered limiting of its scope, the invention will be described and explained with additional specificity and detail through the use of the accompanying drawings in which:

FIG. 1A shows a distance-based anomaly detection approach.

FIG. 1B shows an example set of data points.

FIG. 2 shows an approach to implement an improved anomaly detection system according to some embodiments of the invention.

FIG. 3 shows a flowchart of an approach to implement GKNN according to some embodiments of the invention.

FIGS. 4A-D further explains details with regards to FIG. 3.

FIG. 5 shows a flowchart of an approach to implement GLOF according to some embodiments of the invention.

FIGS. 6A-B illustrate how GLOF can scale up anomaly scores of points near dense clusters.

FIG. 7 plots scaled distances for different points to the respective kth nearest neighbor.

FIG. 8 shows a database context where attributes correspond to specific columns within a database table.

FIG. 9 is a block diagram of an illustrative computing system suitable for implementing an embodiment of the present invention.

FIG. 10 is a block diagram of one or more components of a system environment in which services may be offered as cloud services, in accordance with an embodiment of the present invention.

### DETAILED DESCRIPTION

Some embodiments of the present invention provide an improved approach to implement anomaly detection.

As stated above, one problem with conventional anomaly detection algorithms is that they are very difficult to use by non-specialists, since certain anomaly detection algorithms require the selection and/or tuning of various parameters for the proper operation of the system to accurately detect anomalies. Normally, the non-specialist will not have the proper background or experience to be able to select or tune the required parameters, thereby rendering the detection process to become either unreliable or highly inefficient.

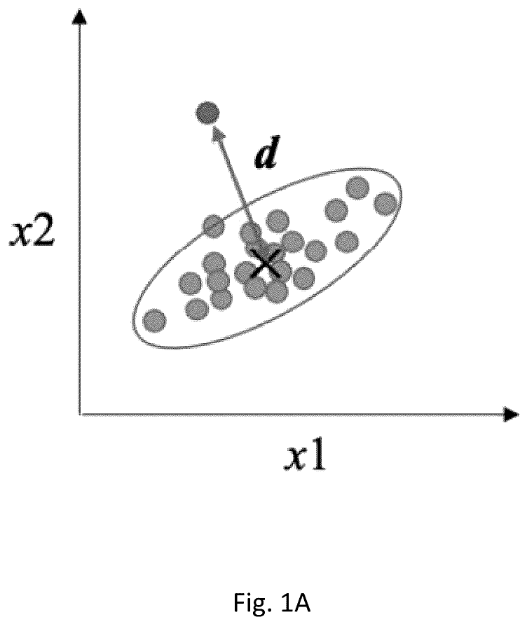

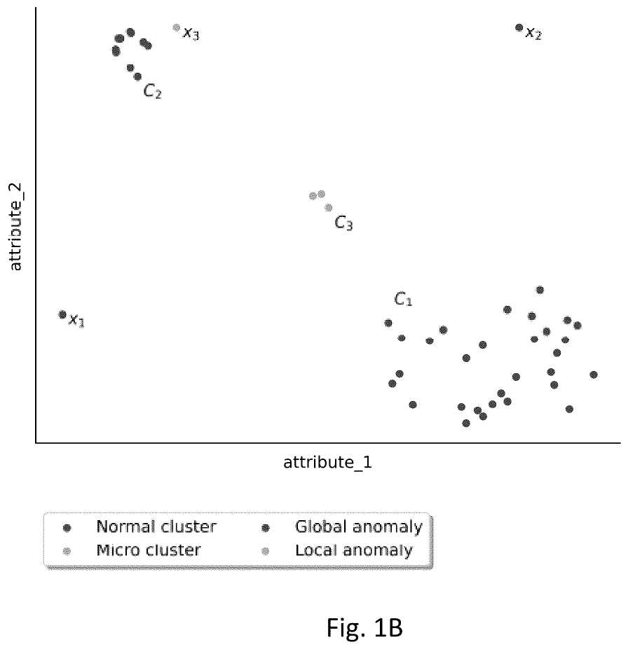

For example, as shown in FIG. 1A, a distance-based anomaly detection algorithms such as KNN and algorithms related to KNN are currently state-of-art in terms of detecting distance-based anomalies. The idea of distance-based outliers dates back at least to the seminal paper by Knox and Raymond where it was shown that for common distributions like the Gaussian or Poisson, outliers have a large distance from other points leading to their proposal to use distance to neighbors as a measure of outlier-ness. This was further developed by multiple other papers where the KNN algorithm is used to calculate the distance to the kth nearest neighbors, and beyond a certain distance threshold, the user could label the point as an outlier.

The KNN approach requires a k parameter value to be set for its proper operation. The k parameter value identifies to the nth number of neighbor values that a given data value is to be compared against when making the anomaly determination. The operation of this algorithm is very sensitive to the correct configuration of this value. As such, this algorithm therefore has a significant drawback, which is its insensitivity to clusters of outliers if an incorrect k is used, since clusters of outliers are a set of outliers that are relatively close together (under some measure) but are relatively far from other points.

What this means is that it may not be possible for the general, non-specialist population of computer users to be able to effectively use this KNN algorithm given the sensitivity of the algorithm to the proper selection of the k value. The problem is that there are numerous computing/software tools that are designed for the general user which may benefit from allowing that general user to be able to take advantage of performing anomaly detection. Such a tool usable by general users includes, for example, the MySQL Heatwave product, available from Oracle Corporation of Redwood Shores, California. However, these end-user focused tools will not be effectively used if they require the users to have the extensive background or experience necessary to be able to correctly select the k value.

Another issue with conventional anomaly detection algorithms is that they tend to be very specialized to detect only certain types of anomalies, while not being able to reliably detect other types of anomalies. To explain, consider the example set of data points shown in FIG. 1B. Here, C1 and C2 represent normal clusters of non-anomalous data points. The “global” anomaly pertains to the type anomaly that corresponds to isolated data outliers. This is illustrated as x1 and x2 in the figure, which are anomalies that is far from all normal points in the chart. The “clustered” anomaly pertains to a set of data points that may group with each other, but overall still correspond to anomalies when compared to normal data. This is illustrated as cluster C3 in the figure, which is an anomaly that is far from closest normal points but close to some other anomalies. The “local” anomaly pertains to isolated data items that may look similar to and has a close distance to good data, but which is actually anomalous data. x3 is an example of the local anomaly in the figure, which is an anomaly that is relatively far from the closest normal points, but possibly the distance between it and the closest normal points is comparable to the distance between other normal points.

The conventional KNN algorithm is known to be effective to detect global anomalies. In this figure, this means that x1 and x2 are likely to be correctly identified by the conventional KNN algorithm. However, as previously pointed out, the operation of this algorithm is very sensitive to the correct configuration of the k value, since there may cause insensitivity to clusters of outliers if an incorrect k is used. Therefore, with the wrong k value, this may cause C3 to not be identified as a clustered anomaly. In addition, if a k value that is too high is selected, then this would cause a local anomaly such as x3 to not be correctly identified as an anomaly.

To address these problems, embodiments of the invention provide an approach that is both (1) as sensitive to the single distance-based outliers as KNN but also sensitive to cluster outliers as well, and (2) does not requires tuning of the parameter k.

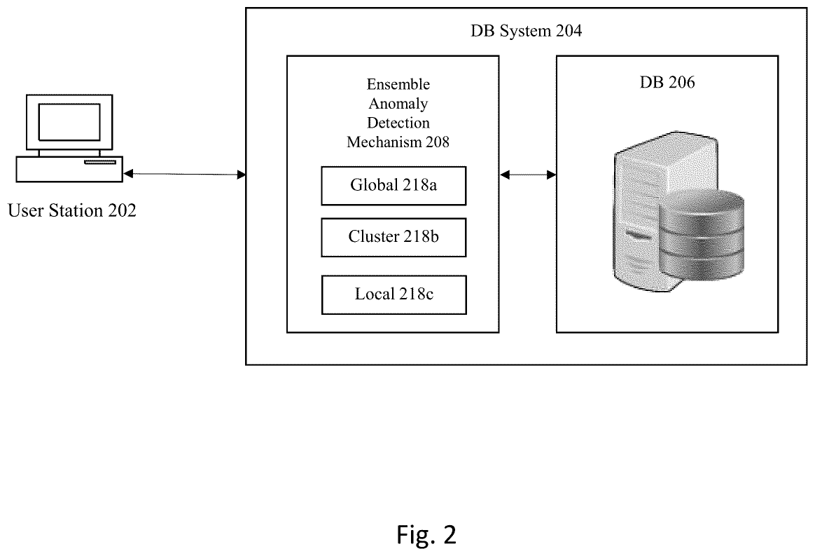

FIG. 2 shows an approach to implement an improved anomaly detection system according to some embodiments of the invention. Provided is an ensemble anomaly detection mechanism 208. This ensemble anomaly detection mechanism 208 comprises multiple detection sub-mechanisms to perform anomaly detection, including a global anomaly detector 218a, a clustered anomaly detector 218b, and a local anomaly detector 218c.

In some embodiments, the multiple anomaly detection sub-mechanisms are implemented using two unsupervised anomaly detection mechanisms/algorithms. One is a generalized k nearest neighbor mechanism/algorithm (GKNN) and the second is an extension of it that is referred to herein as the generalized local outlier factor (GLOF), that can be used to detect distance-based anomalies in tabular datasets. This algorithm detects multiple types of distance-based anomalies by estimating the distance of the anomaly to their respective nearest normal points instead of the distance to the kth nearest neighbor as traditional KNN (K nearest neighbors) does. The major advantage of these algorithms is that they do not require tuning of hyperparameters to achieve high AUC (area under curve) score. This is extremely important because tuning of hyperparameters typically requires a labeled validation set, which is not always available.

The embodiments of the invention may be used in any context in which it is desirable to be able to detect anomalies. In the current illustrative example, the context for the ensemble anomaly detection mechanism 208 is within a database system 204. However, it is noted that the invention is not to be limited only in its application to database systems, unless expressly claimed as such.

The database system 204 may include one or more users or database applications within the system that operate from or uses a user station 202 to issue commands to be processed by database management system (DBMS) upon one or more database tables in a database 206. The user stations and/or the servers that host or operate with the database comprises any type of computing device that may be used to implement, operate, or interface with the database. Examples of such devices include, for example, workstations, personal computers, mobile devices, servers, hosts, nodes, or remote computing terminals. The user station comprises a display device, such as a display monitor, for displaying a user interface to users at the user station. The user station also comprises one or more input devices for the user to provide operational control over the activities of the system, such as a mouse or keyboard to manipulate a pointing object in a graphical user interface to generate user inputs. The database system may be communicatively coupled to a storage apparatus (e.g., a storage subsystem or appliance) over a network. The storage apparatus comprises any storage device that may be employed by the database system to hold storage content.

A database application or user may interact with the database system by submitting commands that cause the database system to perform operations on data stored that is stored in the database. The commands typically conform to a database language supported by the database server. As previously noted, a common example of a database language supported by many database servers is known as the Structured Query Language (SQL). When a database server receives the original statement of a database command from a database application, the database server must first determine which actions should be performed in response to the database command, and then perform those actions. The act of preparing for and/or determining for performance of those actions is generally referred to as compiling the database command, while performing those actions is generally referred to as executing the database command. A database “transaction” corresponds to an all or nothing unit of activity performed at the database that may include any number of different statements or commands for execution.

The system 204 may include the ensemble anomaly detection mechanism 208 to detect data or database-related anomalies. As noted above, the ensemble anomaly detection mechanism implements at least two possible unsupervised anomaly detection algorithms, including GKNN and GLOF. Some embodiments provide an improved approach to implement anomaly detection in databases using an ensemble approach that improves upon existing KNN approaches. Embodiments of the present invention provide an anomaly detection algorithm that is as sensitive as an optimally tuned KNN to single global anomalous points, but without requiring tuning of any parameters. Parameter tuning is a well-known difficulty for unsupervised algorithms, solutions of which include randomization or extensive use of methods that come at the cost of explainability. This disclosure enables avoidance of tuning steps without detriment to the quality of model prediction accuracy.

The invention provides an anomaly detection algorithm that is based on KNN but still sensitive to clusters of anomalies, without requiring tuning any parameters. The relevance of detecting cluster anomalies is demonstrated by the publicly available examples of clustered anomalies where bursts of attacks (clustered anomalies) can be observed in a subset of these anomalies. The attacks in this dataset, which are the anomalies that should be detected, are characterized by their arrival in a short period of time, and having the same values in three attributes, e.g., 2091 out of 2211 anomalies have the same values in attributes: duration, source bytes and destination bytes.

Some embodiments provide an anomaly detection algorithm that is based on KNN but is sensitive to local cluster of anomalies, without requiring tuning of any parameters. This is achieved via extension of algorithm score normalization and scaling of the local anomalies based on the closest cluster density to the local anomaly.

The present approach also provides interpretable results that allow the user to infer the anomaly type and relate it to the anomaly score outputted by the algorithm. This a distance-based model which means that the anomaly scores it assigns to anomalies are directly interpretable as distances to neighbors. This could be of great importance in a business use-case where the user requires interpretable results for analytics or for regulatory purposes.

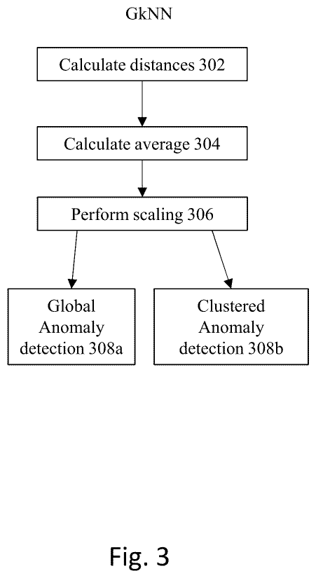

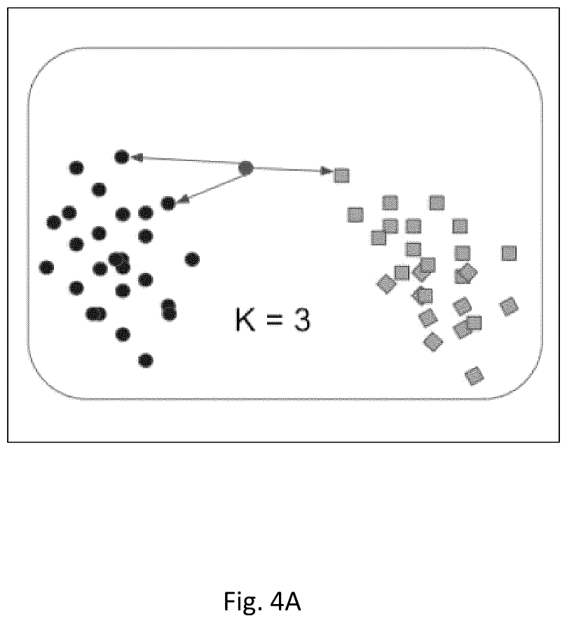

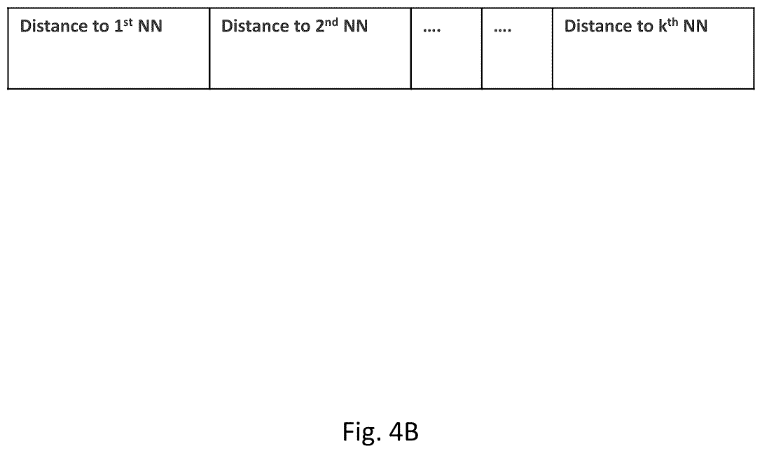

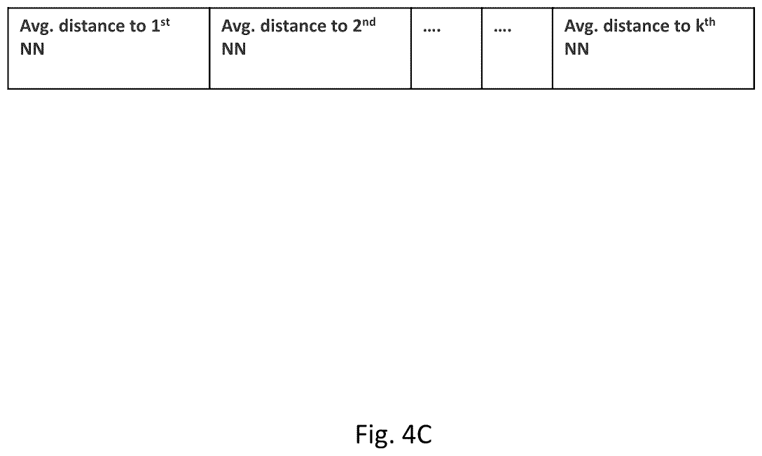

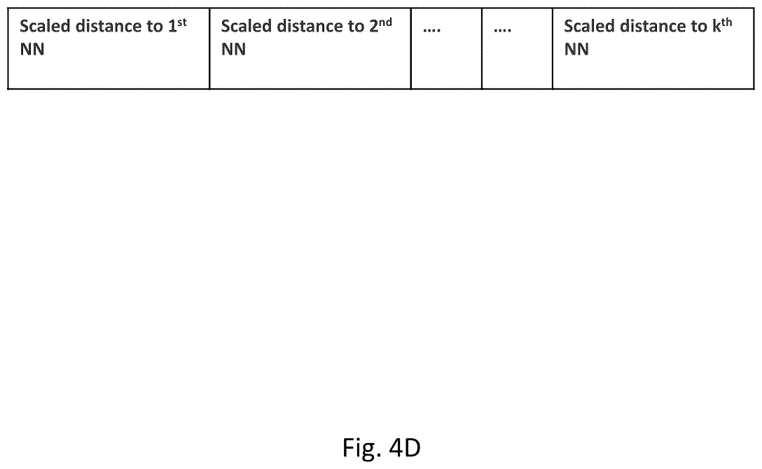

FIG. 3 shows a flowchart of an approach to implement GKNN according to some embodiments of the invention. At step 302, GKNN starts by calculating the distance to the nearest k number of neighbors (e.g., k=100 neighbors) of all the n points in the dataset producing a 2-d array A. A has n rows for each of the n points in the dataset. The ith row of A is: [distance of xᵢ to its 1^{st} nearest neighbor, distance of xᵢ to its 2nd nearest neighbor, . . . , distance of xᵢ to its 100th nearest neighbor]. To explain, consider the chart shown in FIG. 4A. To perform step 302 on these sets of points, a calculation is performed of each point to its nearest k neighbors, e.g., as shown in FIG. 4B to determine the value of Aᵢ.

Next, at step 304, the process then uses A to calculate d the array of size k=100 containing the mean distance of all points to their kth nearest neighbors for all k in [1, 100]. This is used to calculate the average d=mean (Aᵢ), e.g., as shown in FIG. 4C.

At step 306, scaling is performed. This step uses d to scale all the rows of A, resulting in R−the scaled distance matrix. In effect, this step is used to calculate the scaled distances δᵢ: =Aᵢ/d. This action is illustrated in FIG. 4D.

Finally, the output P is the anomaly score for each point, which is the maximum scaled distance of the respective nearest neighbor row. This action is taken to calculate

$${P}_{i} := {max}_{k} {δ}_{i} .$$

A high Pᵢ means that the point xᵢ has an abnormal distance with one of its neighbors (relative to the mean). This means it is more likely to be an anomaly.

By the use of scaling, this means that the algorithm is capable of detecting multiple types of anomalies. Specifically, the use of the max scaled distance is equivalent to using the optimal k to detect each anomaly. At 308a, global anomaly detection can be performed using this approach, where a low k value is used for global anomaly detection. At 308b, clustered anomaly detection can be performed, where a high k value (or at least a high enough k value) is used for clustered anomaly detection.

With regards to local anomalies, a generalized approach may be applied. This approach is referred to herein as Generalized Local Outlier Factor (GLOF), which is an extension of GkNN. This approach can be used to detect global and clustered anomalies like GkNN. However, this approach can also be used to detect local anomalies as well.

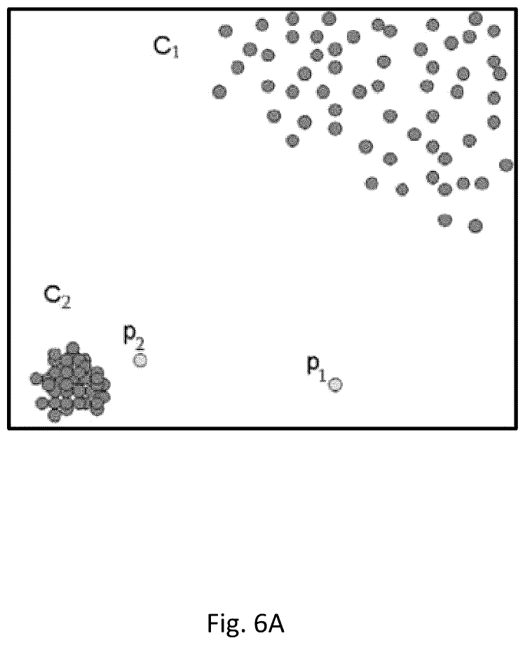

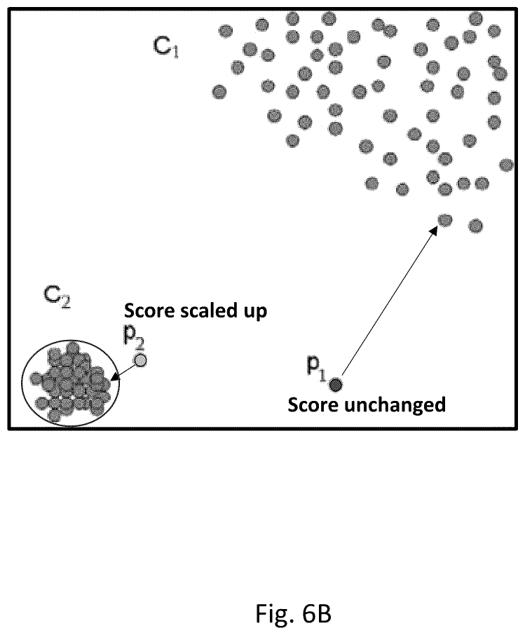

As shown in FIGS. 6A-B, this approach works by essentially having GLOF scale up the anomaly scores of points near dense clusters. FIG. 6A shows a two-dimensional chart of data values to be scored. FIG. 6B shows that p2 corresponds to a cluster where the score(s) can be scaled up for detection purposes. Meanwhile, p1 corresponds to a data item where the score is unchanged.

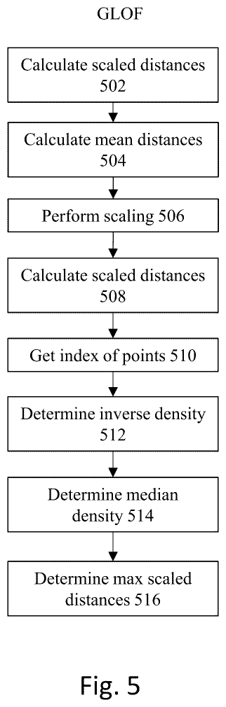

FIG. 5 shows a flowchart of an approach to implement GLOF according to some embodiments of the invention. The GLOF approach is essentially an extension to GKNN which includes an extra step where it multiplies the GKNN's anomaly score by the density of its neighboring cluster if the density of the neighboring cluster is above the median density otherwise it multiplies by the median density. This step allows to emphasize local outliers, making the algorithm sensitive to global and local outliers, as well as clustered outliers.

Therefore, GKNN and GLOF both share the same first 4 steps. Step 502 in FIG. 5 is the same as step 302 in FIG. 3, where a calculation is made of the distance to the nearest k=100 neighbors of all the n points in the dataset producing a 2-d array A. A has n rows for each of the n points in the dataset. The ith row of A is [distance of xᵢ to its 1^{st} nearest neighbor, distance of xᵢ to its 2nd nearest neighbor, . . . , distance of xᵢ to its 100th nearest neighbor]. A calculation is performed of each point to its nearest k neighbors.

Step 504 is the same as 304, where the process uses A to calculate d the array of size k=100 containing the mean distance of all points to their kth nearest neighbors for all k in [1, 100]. This is used to calculate the average d=mean (Aᵢ).

Step 506 is the same as step 306, where scaling is performed. This step uses d to scale all the rows of A, resulting in R−the scaled distance matrix. In effect, this step is used to calculate the scaled distances δᵢ: =Aᵢ/d.

Step 508 is used to calculate a max scaled distance. The output P is the anomaly score for each point, which is the maximum scaled distance of the respective nearest neighbor row. This action is taken to calculate

$${P}_{i} := {max}_{k} {δ}_{i} .$$

A high Pᵢ means that the point xᵢ has an abnormal distance with one of its neighbors (relative to the mean).

GLOF builds up on GKNN by adding steps 510 through 516. At step 510, an index of points is determined. This step is performed by getting an n*1 array of the indices of the points in the neighboring cluster. This is used to determine i=argmax(R). For every data point n, the array contains an index of the nearest point from the nearest normal cluster.

At step 512, for every point n, an inverse density is calculated for the nearest normal cluster computed in step 510. This step calculates an n*1 array of the inverse density of the nearest neighboring normal cluster. This is used to determine e=R[i,k].

Next, at step 514, a median density is determined. This step calculates the median density of all the nearest neighboring normal clusters in the dataset, in effect taking a median across all values computed from step 512. This is used to obtain m=median(e).

Finally, at 516, this step determines the maximum scaled distance. This step calculates n*1 array. The max scaled distance for every point is scaled by the lower value of either the density of the nearest normal neighboring cluster (calculated in step 512) or the median density (calculated in step 514). This is used to calculate P′=P/min(e, m). The process then returns P′ as anomaly scores.

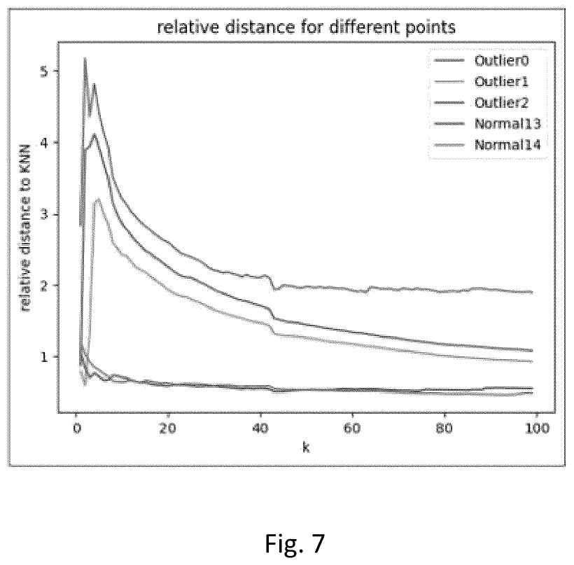

FIG. 7 plots the scaled distances for different illustrative points to the respective kth nearest neighbor. In this setting, outlier 0 and outlier 1 are in a cluster of outliers while outlier 2 is a global anomaly. These types can be inferred from the plot itself. Indeed, for the clustered anomalies, their scaled distances to their respective first nearest neighbor are close to 1 (indicating they are part of some cluster and close to neighbors in that cluster) but as k increases beyond the size of their respective outlier cluster, the max scaled distance increases to a value significantly above 1 and then slowly decreases. This peak or max represents the scaled distance to the nearest normal point. The key assumption is that the sizes of the outlier clusters is less than k=100, thus a peak would always manifest for all outliers, even the ones in outlier clusters.

The k at which the peak is present allows the system to make inferences. For example, if the peak is at k*>1 then the anomaly is in a cluster of anomalies and otherwise (peak at k*=1) it is a global anomaly. If the peak is at k*>1 then the size of the cluster of anomalies is k*. On the other hand, global anomalies are far from any points. By this consequence, they will directly experience a peak from their first neighbor as it is the case for outlier 2.

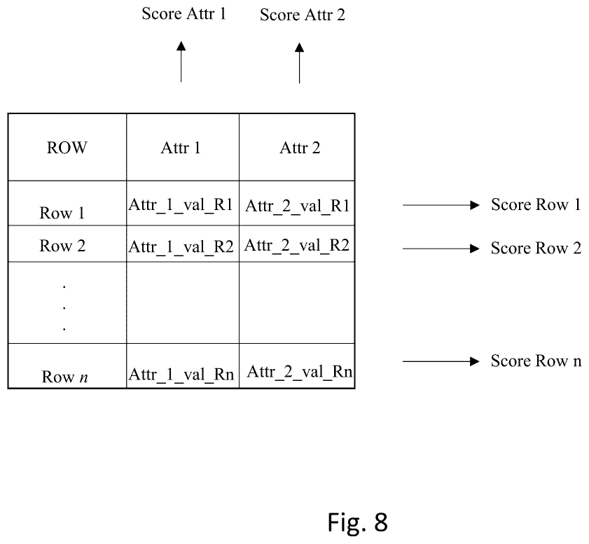

Therefore, the present ensemble approach can be used to effectively detect global, local, and cluster anomalies. For example, in a database context, the attributes may correspond to specific columns within a database table, e.g., as shown in FIG. 8. Specific entries for analysis may pertain to rows within the database table having a given combination of a first attribute and a second attribute from a first and second column, respectively. Scoring may then be used to generate scores for each of the rows within the database table. The scoring may be applied based upon scoring for individual attributes/columns in the table. The embodiments may be applied to any other use cases in which data for attributes are stored in a relational database structure, e.g., where network data is stored in a database structure and analyzed as disclosed herein to identify network-related anomalies.

The invention may be implemented to provide automated machine learning capabilities into a database management system, e.g., using a MySQL interface (referred to herein as MySQL Heatwave AutoML). This implements anomaly detection in the database system, e.g., where the anomaly detection (also sometimes referred to as outlier detection or novelty detection) performs a study of and identification of observations deviating significantly from normal behavior. This performs at least one or more of the four main data mining tasks, such as for example, classification, regression, clustering, and/or anomaly detection. Applications of anomaly detection in the database context may include, for example, data cleaning, medical discordancy to detect potentially life-threatening situations, financial fraud detection, and/or industrial fault and damage detection.

Numerous advantages may be provided by embodiments of the invention. For example, the present approach may achieve generalization of KNN mechanisms through the use of an approach that tries multiple values of k for KNN for each data point and selects the optimal value for each point instead of using a static value for all the points. This dynamic selection of k allows the use of a low k for global anomalies and a high enough value of k for cluster anomalies. Thus, the method has optimal sensitivity to anomaly types without the need of manual parameter selection.

An extension to the proposed algorithm to make it sensitive to local anomalies is the GLOF algorithm which multiplies the GKNN's anomaly score by the density of its neighboring cluster if the density of the neighboring cluster is above the median density otherwise it multiplies by the median density.

The third and fourth steps in GKNN are improvements and extensions of KNN algorithm, as scaling of scores in the current approach leads to making the algorithm more sensitive to global and clustered anomalies.

The fifth through eighth steps in GLOF are improvements to GKNN as they further compare the closest cluster to a local anomaly and further scale the distance of that anomaly based on the density of the closest cluster.

The present approach also improves the functioning of a computer system itself. To explain, consider that prior non-optimal approaches would have needed to run three separate algorithms to achieve the ability to address global, local, and cluster anomalies. In contrast, the current embodiment can handle all three types of anomalies in one ensemble process flow. This ability to avoid having to run three separate processing approaches means that the system resources needed to achieve the same results can be reduced by a significant amount, e.g., less processor/CPU resources are needed since less processing is required with the present approach. In addition, memory resources are conserved since less data would need to be loaded into memory because the current ensemble approach is employed, versus needing at least three times as much memory if three separate processing runs are performed for separate algorithms for each of the of the local, global, and cluster anomaly detections.

In addition, it is noted that one of the biggest pain points in machine learning, especially in the context of anomaly detection, is the lack of datasets with labels. Labeling these datasets is time consuming as it requires a human with domain expertise in most cases or is just infeasible due to specialty or clearance requirements. The present approach addresses this problem by removing the necessity to have labeled data and still providing state of the art performance with sensitivity to multiple types of outliers. This will enable Oracle to provide customers with anomaly detection models that have reasonably state of the art accuracy, even when the customer cannot provide labeled data and does not know the nature of the anomalies in the dataset.

### System Architecture

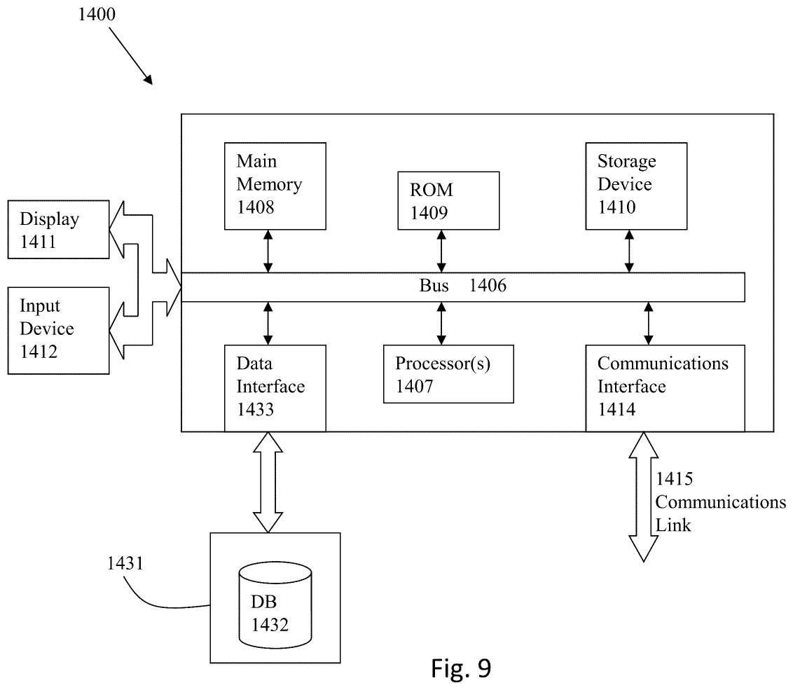

FIG. 9 is a block diagram of an illustrative computing system 1400 suitable for implementing an embodiment of the present invention. Computer system 1400 includes a bus 1506 or other communication mechanism for communicating information, which interconnects subsystems and devices, such as processor 1407, system memory 1408 (e.g., RAM), static storage device 1409 (e.g., ROM), disk drive 1410 (e.g., magnetic or optical), communication interface 1414 (e.g., modem or Ethernet card), display 1411 (e.g., CRT or LCD), input device 1412 (e.g., keyboard), and cursor control.

According to some embodiments of the invention, computer system 1400 performs specific operations by processor 1407 executing one or more sequences of one or more instructions contained in system memory 1408. Such instructions may be read into system memory 1408 from another computer readable/usable medium, such as static storage device 1409 or disk drive 1410. In alternative embodiments, hard-wired circuitry may be used in place of or in combination with software instructions to implement the invention. Thus, embodiments of the invention are not limited to any specific combination of hardware circuitry and/or software. In some embodiments, the term “logic” shall mean any combination of software or hardware that is used to implement all or part of the invention.

The term “computer readable medium” or “computer usable medium” as used herein refers to any medium that participates in providing instructions to processor 1407 for execution. Such a medium may take many forms, including but not limited to, non-volatile media and volatile media. Non-volatile media includes, for example, optical or magnetic disks, such as disk drive 1410. Volatile media includes dynamic memory, such as system memory 1408.

Common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

In an embodiment of the invention, execution of the sequences of instructions to practice the invention is performed by a single computer system 1400. According to other embodiments of the invention, two or more computer systems 1400 coupled by communication link 1410 (e.g., LAN, PTSN, or wireless network) may perform the sequence of instructions required to practice the invention in coordination with one another.

Computer system 1400 may transmit and receive messages, data, and instructions, including program, i.e., application code, through communication link 1415 and communication interface 1414. Received program code may be executed by processor 1407 as it is received, and/or stored in disk drive 1410, or other non-volatile storage for later execution. A database 1432 in a storage medium 1431 may be used to store data accessible by the system 1400.

The techniques described may be implemented using various processing systems, such as clustered computing systems, distributed systems, and cloud computing systems. In some embodiments, some or all of the data processing system described above may be part of a cloud computing system. Cloud computing systems may implement cloud computing services, including cloud communication, cloud storage, and cloud processing.

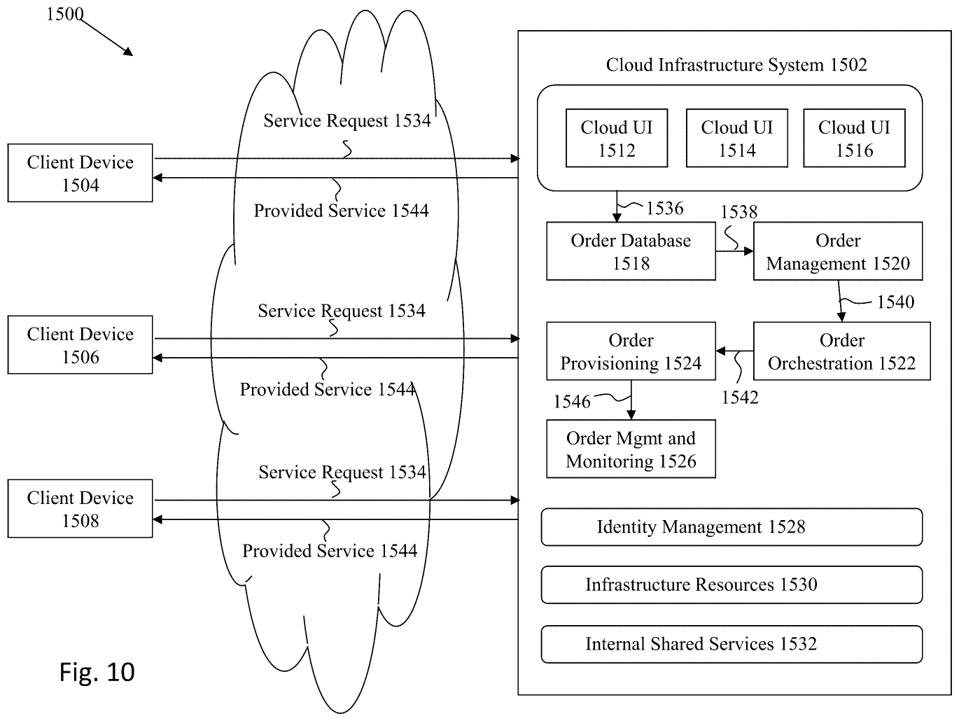

FIG. 10 is a simplified block diagram of one or more components of a system environment 1500 by which services provided by one or more components of an embodiment system may be offered as cloud services, in accordance with an embodiment of the present disclosure. In the illustrated embodiment, system environment 1500 includes one or more client computing devices 1504, 1506, and 1508 that may be used by users to interact with a cloud infrastructure system 1502 that provides cloud services. The client computing devices may be configured to operate a client application such as a web browser, a proprietary client application, or some other application, which may be used by a user of the client computing device to interact with cloud infrastructure system 1502 to use services provided by cloud infrastructure system 1502.

It should be appreciated that cloud infrastructure system 1502 depicted in the figure may have other components than those depicted. Further, the embodiment shown in the figure is only one example of a cloud infrastructure system that may incorporate an embodiment of the invention. In some other embodiments, cloud infrastructure system 1502 may have more or fewer components than shown in the figure, may combine two or more components, or may have a different configuration or arrangement of components.

Client computing devices 1504, 1506, and 1508 may be devices similar to those described above for FIG. 9. Although system environment 1500 is shown with three client computing devices, any number of client computing devices may be supported. Other devices such as devices with sensors, etc. may interact with cloud infrastructure system 1502.

Network(s) 1510 may facilitate communications and exchange of data between clients 1504, 1506, and 1508 and cloud infrastructure system 1502. Each network may be any type of network familiar to those skilled in the art that can support data communications using any of a variety of commercially-available protocols. Cloud infrastructure system 1502 may comprise one or more computers and/or servers.

In certain embodiments, services provided by the cloud infrastructure system may include a host of services that are made available to users of the cloud infrastructure system on demand, such as online data storage and backup solutions, Web-based e-mail services, hosted office suites and document collaboration services, database processing, managed technical support services, and the like. Services provided by the cloud infrastructure system can dynamically scale to meet the needs of its users. A specific instantiation of a service provided by cloud infrastructure system is referred to herein as a “service instance.” In general, any service made available to a user via a communication network, such as the Internet, from a cloud service provider's system is referred to as a “cloud service.” Typically, in a public cloud environment, servers and systems that make up the cloud service provider's system are different from the customer's own on-premises servers and systems. For example, a cloud service provider's system may host an application, and a user may, via a communication network such as the Internet, on demand, order and use the application.

In some examples, a service in a computer network cloud infrastructure may include protected computer network access to storage, a hosted database, a hosted web server, a software application, or other service provided by a cloud vendor to a user, or as otherwise known in the art. For example, a service can include password-protected access to remote storage on the cloud through the Internet. As another example, a service can include a web service-based hosted relational database and a script-language middleware engine for private use by a networked developer. As another example, a service can include access to an email software application hosted on a cloud vendor's web site.

In certain embodiments, cloud infrastructure system 1502 may include a suite of applications, middleware, and database service offerings that are delivered to a customer in a self-service, subscription-based, elastically scalable, reliable, highly available, and secure manner.

In various embodiments, cloud infrastructure system 1502 may be adapted to automatically provision, manage and track a customer's subscription to services offered by cloud infrastructure system 1502. Cloud infrastructure system 1502 may provide the cloudservices via different deployment models. For example, services may be provided under a public cloud model in which cloud infrastructure system 1502 is owned by an organization selling cloud services and the services are made available to the general public or different industry enterprises. As another example, services may be provided under a private cloud model in which cloud infrastructure system 1502 is operated solely for a single organization and may provide services for one or more entities within the organization. The cloud services may also be provided under a community cloud model in which cloud infrastructure system 1502 and the services provided by cloud infrastructure system 1502 are shared by several organizations in a related community. The cloud services may also be provided under a hybrid cloud model, which is a combination of two or more different models.

In some embodiments, the services provided by cloud infrastructure system 1502 may include one or more services provided under Software as a Service (SaaS) category, Platform as a Service (PaaS) category, Infrastructure as a Service (IaaS) category, or other categories of services including hybrid services. A customer, via a subscription order, may order one or more services provided by cloud infrastructure system 1502. Cloud infrastructure system 1502 then performs processing to provide the services in the customer's subscription order.

In some embodiments, the services provided by cloud infrastructure system 1502 may include, without limitation, application services, platform services and infrastructure services. In some examples, application services may be provided by the cloud infrastructure system via a SaaS platform. The SaaS platform may be configured to provide cloud services that fall under the SaaS category. For example, the SaaS platform may provide capabilities to build and deliver a suite of on-demand applications on an integrated development and deployment platform. The SaaS platform may manage and control the underlying software and infrastructure for providing the SaaS services. By utilizing the services provided by the SaaS platform, customers can utilize applications executing on the cloud infrastructure system. Customers can acquire the application services without the need for customers to purchase separate licenses and support. Various different SaaS services may be provided. Examples include, without limitation, services that provide solutions for sales performance management, enterprise integration, and business flexibility for large organizations.

In some embodiments, platform services may be provided by the cloud infrastructure system via a PaaS platform. The PaaS platform may be configured to provide cloud services that fall under the PaaS category. Examples of platform services may include without limitation services that enable organizations to consolidate existing applications on a shared, common architecture, as well as the ability to build new applications that leverage the shared services provided by the platform. The PaaS platform may manage and control the underlying software and infrastructure for providing the PaaS services. Customers can acquire the PaaS services provided by the cloud infrastructure system without the need for customers to purchase separate licenses and support.

By utilizing the services provided by the PaaS platform, customers can employ programming languages and tools supported by the cloud infrastructure system and also control the deployed services. In some embodiments, platform services provided by the cloud infrastructure system may include database cloud services, middleware cloud services, and Java cloud services. In one embodiment, database cloud services may support shared service deployment models that enable organizations to pool database resources and offer customers a Database as a Service in the form of a database cloud. Middleware cloud services may provide a platform for customers to develop and deploy various business applications, and Java cloud services may provide a platform for customers to deploy Java applications, in the cloud infrastructure system.

Various different infrastructure services may be provided by an IaaS platform in the cloud infrastructure system. The infrastructure services facilitate the management and control of the underlying computing resources, such as storage, networks, and other fundamental computing resources for customers utilizing services provided by the SaaS platform and the PaaS platform.

In certain embodiments, cloud infrastructure system 1502 may also include infrastructure resources 1530 for providing the resources used to provide various services to customers of the cloud infrastructure system. In one embodiment, infrastructure resources 1530 may include pre-integrated and optimized combinations of hardware, such as servers, storage, and networking resources to execute the services provided by the PaaS platform and the SaaS platform.

In some embodiments, resources in cloud infrastructure system 1502 may be shared by multiple users and dynamically re-allocated per demand. Additionally, resources may be allocated to users in different time zones. For example, cloud infrastructure system 1502 may enable a first set of users in a first time zone to utilize resources of the cloud infrastructure system for a specified number of hours and then enable the re-allocation of the same resources to another set of users located in a different time zone, thereby maximizing the utilization of resources.

In certain embodiments, a number of internal shared services 1532 may be provided that are shared by different components or modules of cloud infrastructure system 1502 and by the services provided by cloud infrastructure system 1502. These internal shared services may include, without limitation, a security and identity service, an integration service, an enterprise repository service, an enterprise manager service, a virus scanning and white list service, a high availability, backup and recovery service, service for enabling cloud support, an email service, a notification service, a file transfer service, and the like.

In certain embodiments, cloud infrastructure system 1502 may provide comprehensive management of cloud services (e.g., SaaS, PaaS, and IaaS services) in the cloud infrastructure system. In one embodiment, cloud management functionality may include capabilities for provisioning, managing and tracking a customer's subscription received by cloud infrastructure system 1502, and the like.

In one embodiment, as depicted in the figure, cloud management functionality may be provided by one or more modules, such as an order management module 1520, an order orchestration module 1522, an order provisioning module 1524, an order management and monitoring module 1526, and an identity management module 1528. These modules may include or be provided using one or more computers and/or servers, which may be general purpose computers, specialized server computers, server farms, server clusters, or any other appropriate arrangement and/or combination.

In operation 1534, a customer using a client device, such as client device 1504, 1506 or 1508, may interact with cloud infrastructure system 1502 by requesting one or more services provided by cloud infrastructure system 1502 and placing an order for a subscription for one or more services offered by cloud infrastructure system 1502. In certain embodiments, the customer may access a cloud User Interface (UI), cloud UI 1512, cloud UI 1514 and/or cloud UI 1516 and place a subscription order via these UIs. The order information received by cloud infrastructure system 1502 in response to the customer placing an order may include information identifying the customer and one or more services offered by the cloud infrastructure system 1502 that the customer intends to subscribe to.

After an order has been placed by the customer, the order information is received via the cloud UIs, 1512, 1514 and/or 1516. At operation 1536, the order is stored in order database 1518. Order database 1518 can be one of several databases operated by cloud infrastructure system 1518 and operated in conjunction with other system elements. At operation 1538, the order information is forwarded to an order management module 1520. In some instances, order management module 1520 may be configured to perform billing and accounting functions related to the order, such as verifying the order, and upon verification, booking the order. At operation 1540, information regarding the order is communicated to an order orchestration module 1522. Order orchestration module 1522 may utilize the order information to orchestrate the provisioning of services and resources for the order placed by the customer. In some instances, order orchestration module 1522 may orchestrate the provisioning of resources to support the subscribed services using the services of order provisioning module 1524.

In certain embodiments, order orchestration module 1522 enables the management of business processes associated with each order and applies business logic to determine whether an order should proceed to provisioning. At operation 1542, upon receiving an order for a new subscription, order orchestration module 1522 sends a request to order provisioning module 1524 to allocate resources and configure those resources needed to fulfill the subscription order. Order provisioning module 1524 enables the allocation of resources for the services ordered by the customer. Order provisioning module 1524 provides a level of abstraction between the cloud services provided by cloud infrastructure system 1502 and the physical implementation layer that is used to provision the resources for providing the requested services. Order orchestration module 1522 may thus be isolated from implementation details, such as whether or not services and resources are actually provisioned on the fly or pre-provisioned and only allocated/assigned upon request.

At operation 1544, once the services and resources are provisioned, a notification of the provided service may be sent to customers on client devices 1504, 1506 and/or 1508 by order provisioning module 1524 of cloud infrastructure system 1502.

At operation 1546, the customer's subscription order may be managed and tracked by an order management and monitoring module 1526. In some instances, order management and monitoring module 1526 may be configured to collect usage statistics for the services in the subscription order, such as the amount of storage used, the amount data transferred, the number of users, and the amount of system up time and system down time.

In certain embodiments, cloud infrastructure system 1502 may include an identity management module 1528. Identity management module 1528 may be configured to provide identity services, such as access management and authorization services in cloud infrastructure system 1502. In some embodiments, identity management module 1528 may control information about customers who wish to utilize the services provided by cloud infrastructure system 1502. Such information can include information that authenticates the identities of such customers and information that describes which actions those customers are authorized to perform relative to various system resources (e.g., files, directories, applications, communication ports, memory segments, etc.) Identity management module 1528 may also include the management of descriptive information about each customer and about how and by whom that descriptive information can be accessed and modified.

In the foregoing specification, the invention has been described with reference to specific embodiments thereof. It will, however, be evident that various modifications and changes may be made thereto without departing from the broader spirit and scope of the invention. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense.

What is claimed is:

1. A method, comprising:
identifying data to be analyzed for anomaly detection;
analyzing the data using an ensemble detection mechanism that comprises multiple anomaly detection mechanisms;
performing scaling to adjust a detection parameter, where the scaling is adjusted to perform detection of a global anomaly at a first value for the detection parameter and detection of a cluster anomaly at a second value for the detection parameter; and
outputting an indication of whether a given data point corresponds to an anomaly.

2. The method of claim 1, wherein the multiple anomaly detection mechanisms comprise a generalized k nearest neighbor mechanism, where the detection parameter that is scaled comprises a k parameter.

3. The method of claim 2, wherein the k parameter is dynamically selected.

4. The method of claim 2, wherein a first k value used for the detection of the global anomaly is relatively lower than a second k value used for detection of the clustered anomaly.

5. The method of claim 1, wherein the multiple anomaly detection mechanisms comprise a mechanism that performs:
calculating a distance to a nearest set of k neighbors of n points in a dataset to produce a two-dimensional array A;
using A to calculate d corresponding to an array containing mean distances of points to their kth nearest neighbors;
performing the scaling to scale rows of A to produce a scaled distance matrix; and
generating an anomaly score corresponding to a scaled distance from a nearest neighbor row.

6. The method of claim 5, further comprising:
determining an index of points in a neighboring cluster;
calculating an inverse density of the neighboring cluster;
determining a median density of the neighboring cluster; and
calculating a maximum scaled distance based upon density, and using the maximum scaled distance to generate the anomaly score for a local anomaly.

7. The method of claim 1, wherein the multiple anomaly detection mechanisms comprise a generalized k nearest neighbor mechanism which scales up anomaly scores of points near dense clusters.

8. The method of claim 1, wherein attributes of the data analyzed by the ensemble detection mechanism correspond to columns within a database table, and scoring is generated for a given row of the database table.

9. A system, comprising:
a processor;
a memory for holding programmable code; and
wherein the programmable code includes instructions executable by the processor for identifying data to be analyzed for anomaly detection; analyzing the data using an ensemble detection mechanism that comprises multiple anomaly detection mechanisms; performing scaling to adjust a detection parameter, where the scaling is adjusted to perform detection of a global anomaly at a first value for the detection parameter and detection of a cluster anomaly at a second value for the detection parameter; and outputting an indication of whether a given data point corresponds to an anomaly.

10. The system of claim 9, wherein the multiple anomaly detection mechanisms comprise a generalized k nearest neighbor mechanism, where the detection parameter that is scaled comprises a k parameter.

11. The system of claim 10, wherein the k parameter is dynamically selected.

12. The system of claim 10, wherein a first k value used for the detection of the global anomaly is relatively lower than a second k value used for detection of the clustered anomaly.

13. The system of claim 9, wherein the multiple anomaly detection mechanisms comprise a mechanism that performs:
calculating a distance to a nearest set of k neighbors of n points in a dataset to produce a two-dimensional array A;
using A to calculate d corresponding to an array containing mean distances of points to their kth nearest neighbors;
performing the scaling to scale rows of A to produce a scaled distance matrix; and
generating an anomaly score corresponding to a scaled distance from a nearest neighbor row.

14. The system of claim 13, wherein the programmable code further performs:
determining an index of points in a neighboring cluster;
calculating an inverse density of the neighboring cluster;
determining a median density of the neighboring cluster; and
calculating a maximum scaled distance based upon density, and using the maximum scaled distance to generate the anomaly score for a local anomaly.

15. The system of claim 9, wherein the multiple anomaly detection mechanisms comprise a generalized k nearest neighbor algorithm which scales up anomaly scores of points near dense clusters.

16. The system of claim 9, wherein attributes of the data analyzed by the ensemble detection mechanism correspond to columns within a database table, and scoring is generated for a given row of the database table.

17. A computer program product embodied on a computer readable medium, the computer readable medium having stored thereon a sequence of instructions which, when executed by a processor, executes at least:
identifying data to be analyzed for anomaly detection;
analyzing the data using an ensemble detection mechanism that comprises multiple anomaly detection mechanisms;
performing scaling to adjust a detection parameter, where the scaling is adjusted to perform detection of a global anomaly at a first value for the detection parameter and detection of a cluster anomaly at a second value for the detection parameter; and
outputting an indication of whether a given data point corresponds to an anomaly.

18. The computer program product of claim 17, wherein the multiple anomaly detection mechanisms comprise a generalized k nearest neighbor mechanism, where the detection parameter that is scaled comprises a k parameter.

19. The computer program product of claim 18, wherein the k parameter is dynamically selected.

20. The computer program product of claim 18, wherein a first k value used for the detection of the global anomaly is relatively lower than a second k value used for detection of the clustered anomaly.

21. The computer program product of claim 17, wherein the multiple anomaly detection mechanisms comprise a mechanism that performs:
calculating a distance to a nearest set of k neighbors of n points in a dataset to produce a two-dimensional array A;
using A to calculate d corresponding to an array containing mean distances of points to their kth nearest neighbors;
performing the scaling to scale rows of A to produce a scaled distance matrix; and
generating an anomaly score corresponding to a scaled distance from a nearest neighbor row.

22. The computer program product of claim 21, further comprising:
determining an index of points in a neighboring cluster;
calculating an inverse density of the neighboring cluster;
determining a median density of the neighboring cluster; and
calculating a maximum scaled distance based upon density, and using the maximum scaled distance to generate the anomaly score for a local anomaly.

23. The computer program product of claim 17, wherein the multiple anomaly detection mechanisms comprise a generalized k nearest neighbor mechanism which scales up anomaly scores of points near dense clusters.

24. The computer program product of claim 17, wherein attributes of the data analyzed by the ensemble detection mechanism correspond to columns within a database table, and scoring is generated for a given row of the database table.
